(19) United States
(12) Patent Application Publication
(10) Pub. No.: US 2015/0065288 A1
(43) Pub. Date: Mar. 5, 2015

(54) MULTI-MODE CONTINUOUSLY VARIABLE TRANSMISSION WITH TRANSFER GEAR SET

(71) Applicant: GM Global Technology Operations LLC, Detroit, MI (US)

(72) Inventors: Edward W. Mellet, ROCHESTER HILLS, MI (US); JAMES M. HART, BELLEVILLE, MI (US); LEONID BASIN, FARMINGTON HILLS, MI (US)

(21) Appl. No.: 14/466,128

(22) Filed: Aug. 22, 2014

Related U.S. Application Data
(60) Provisional application No. 61/871,578, filed on Aug. 29, 2013.

(51) Int. Cl. F16H 37/02; F16H 9/12

(52) U.S. Cl. CPC F16H 37/022; F16H 9/12
USPC 475/210

(57) ABSTRACT

A multi-mode continuously variable transmission (CVT) for a motor vehicle includes a transfer gear set connected upstream in a powerflow to a pulley and belt assembly. The pulley and belt assembly is connected upstream in the powerflow to a planetary gear set arrangement. The planetary gear set arrangement generally includes two planetary gear sets, two brakes, and one clutch. The planetary gear set arrangement is connected to a final drive unit.

### CROSS-REFERENCE TO RELATED APPLICATIONS

This application claims the benefit of U.S. Provisional Application No. 61/871,578 filed Aug. 29, 2013. The disclosure of the above application is incorporated herein by reference.

### FIELD

The present disclosure relates to automatic transmissions and more particularly to a multi-mode continuously variable transmission having a transfer gear set.

### BACKGROUND

The statements in this section merely provide background information related to the present disclosure and may or may not constitute prior art.

A continuously variable transmission (“CVT”) typically includes a belt and pulley system that operatively couples a rotary power source, such as an engine or electric motor, to a double gear final drive unit. The belt and pulley system generally includes first and second pairs of pulley cones having a torque transmitting belt or chain extending between the cone pairs. Each pulley cone pair includes an axially stationary pulley member and an axially movable pulley member. Each movable pulley member is axially adjustable with respect to the stationary pulley member by a hydraulic system. The hydraulic system provides primary and secondary hydraulic pressures to the respective movable pulley members to adjust the running radius of the first and second pulley cone pairs which in turn controls the output/input ratio of the continuously variable transmission. Movement of the cones steplessly or continuously varies the ratio of an input speed to an output speed. With the continuously variable transmission, small but effective ratio changes can be attained. This is in contrast to a fixed gear ratio unit where any ratio changes are step values.

CVT axial length and mass significantly impact its power density and efficiency. CVT designs that reduce the number of axes of rotation may be particularly desirable in certain configurations. Accordingly, there is a constant need for improved CVT designs that minimize axial length and mass while providing sufficient performance characteristics and having a minimized number of axes of rotation.

### SUMMARY

A multi-mode CVT is provided for a motor vehicle. The multi-mode CVT includes a transfer gear set or speed change device connected to a pulley and belt assembly. The pulley and belt assembly is also connected to a planetary gear set arrangement. The planetary gear set arrangement generally includes two planetary gear sets, two brakes, and one clutch. The planetary gear set arrangement is connected to a final drive unit.

For example, in one aspect of the present invention a transmission for a motor vehicle includes a transmission input member, a transmission output member, a transfer gear set having a first transfer member connected for common rotation with the transmission input member and having a second transfer member in mesh with the first transfer member, a continuously variable unit having a first pulley connected for common rotation with the second transfer member of the transfer gear, a second pulley, and an endless member wrapped around the first pulley and the second pulley, a first planetary gear set having a plurality of members, a second planetary gear set having a plurality of members, wherein the second planetary gear set is connected for common rotation to the first planetary gear set, the second pulley, and the transmission output member, a clutch for selectively connecting for common rotation the first planetary gear set to the second planetary gear set, a first brake for selectively connecting the first planetary gear set to a stationary member, and a second brake for selectively connecting the second planetary gear set to the stationary member. Selective engagement of the clutch, first brake, second brake, and selective movement of the first pulley and second pulley provides two forward ranges of continuous gear ratios between the transmission input member and the transmission output member.

In another aspect of the present invention, the first planetary gear set includes a first member, a second member, and a third member and the second planetary gear set includes a first member, a second member, and a third member, wherein the first member of the first planetary gear set is connected for common rotation with the second member of the second planetary gear set, and the second member of the first planetary gear set is connected for common rotation with the third member of the second planetary gear set.

In yet another aspect of the present invention, the first member of the second planetary gear set is connected for common rotation with the second pulley and the second member of the first planetary gear set and the third member of the second planetary gear set are connected for common rotation with the transmission output member.

In yet another aspect of the present invention, the clutch selectively connects for common rotation the first member of the first planetary gear set and the second member of the second planetary gear set to the second member of the first planetary gear set and the third member of the second planetary gear set.

In yet another aspect of the present invention, the first brake selectively connects the first member of the first planetary gear set and the second member of the second planetary gear set to the stationary member.

In yet another aspect of the present invention, the second brake selectively connects the third member of the first planetary gear set to the stationary member.

In yet another aspect of the present invention, the first member of the first planetary gear set and the second member of the second planetary gear set are integrally formed as a single rotating member.

In yet another aspect of the present invention, the second member of the first planetary gear set and the third member of the second planetary gear set are integrally formed as a single rotating member.

In yet another aspect of the present invention, the first member of the first planetary gear set is a ring gear, the second member of the first planetary gear set is a planet carrier member, the third member of the first planetary gear set is a sun gear, the first member of the second planetary gear set is a sun gear, the second member of the second planetary gear set is a ring gear, and the third member of the second planetary gear set is a planet carrier member.

In yet another aspect of the present invention, the second member of the first planetary gear set and the third member of the second planetary gear set both support a plurality of stepped pinions and a plurality of pinions, wherein each of the plurality of stepped pinions have a first portion in mesh with the third member of the first planetary gear set and a second portion in mesh with the integrally formed first member of the first planetary gear set and the second member of the second planetary gear set and in mesh with the plurality of pinions, and wherein the plurality of pinions are in mesh with the first member of the second planetary gear set.

In yet another aspect of the present invention, the first gear member is co-planar with the second gear set.

In yet another aspect of the present invention, a rotating member is directly connected with the second transfer member and the second planetary gear set, and wherein the transfer gear set is an overdrive transfer gear set that increases a speed and decreases a torque of the rotating member relative to the transmission input member.

In yet another aspect of the present invention, the transfer gear set is an underdrive transfer gear set that decreases a speed and increases a torque of the rotating member relative to the transmission input member.

In yet another aspect of the present invention, the transfer gear set is a direct drive transfer gear set that maintains a speed and a torque of the rotating member relative to the transmission input member.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and is not intended to limit the scope of the present disclosure in any way.

FIG. 1 is a schematic diagram of a powertrain according to the principles of the present invention;

FIG. 2A is a schematic lever diagram of an exemplary transmission according to the principles of the present invention;

FIG. 2B is a schematic lever diagram of another exemplary transmission according to the principles of the present invention;

FIG. 2C is a schematic lever diagram of another exemplary transmission according to the principles of the present invention;

FIG. 2D is a schematic lever diagram of another exemplary transmission according to the principles of the present invention;

FIG. 2E is a schematic lever diagram of another exemplary transmission according to the principles of the present invention;

FIG. 2F is a schematic lever diagram of another exemplary transmission according to the principles of the present invention;

FIG. 3A is a diagrammatic illustration of an embodiment of a transmission according to the principles of the present invention;

FIG. 3B is a diagrammatic illustration of another embodiment of a transmission according to the principles of the present invention;

FIG. 3C is a diagrammatic illustration of another embodiment of a transmission according to the principles of the present invention;

FIG. 3D is a diagrammatic illustration of another embodiment of a transmission according to the principles of the present invention;

FIG. 3E is a diagrammatic illustration of another embodiment of a transmission according to the principles of the present invention;

FIG. 3F is a diagrammatic illustration of another embodiment of a transmission according to the principles of the present invention;

FIG. 4A is a diagrammatic illustration of another embodiment of a transmission according to the principles of the present invention;

FIG. 4B is a diagrammatic illustration of another embodiment of a transmission according to the principles of the present invention;

FIG. 4C is a diagrammatic illustration of another embodiment of a transmission according to the principles of the present invention;

FIG. 4D is a diagrammatic illustration of another embodiment of a transmission according to the principles of the present invention;

FIG. 4E is a diagrammatic illustration of another embodiment of a transmission according to the principles of the present invention;

FIG. 4F is a diagrammatic illustration of another embodiment of a transmission according to the principles of the present invention;

FIG. 5A is a diagrammatic illustration of another embodiment of a transmission according to the principles of the present invention;

FIG. 5B is a diagrammatic illustration of another embodiment of a transmission according to the principles of the present invention;

FIG. 5C is a diagrammatic illustration of another embodiment of a transmission according to the principles of the present invention;

FIG. 5D is a diagrammatic illustration of another embodiment of a transmission according to the principles of the present invention;

FIG. 5E is a diagrammatic illustration of another embodiment of a transmission according to the principles of the present invention;

FIG. 5F is a diagrammatic illustration of another embodiment of a transmission according to the principles of the present invention;

FIG. 6A is a schematic lever diagram of an exemplary transmission according to the principles of the present invention;

FIG. 6B is a schematic lever diagram of another exemplary transmission according to the principles of the present invention;

FIG. 6C is a schematic lever diagram of another exemplary transmission according to the principles of the present invention;

FIG. 6D is a schematic lever diagram of another exemplary transmission according to the principles of the present invention;

FIG. 6E is a schematic lever diagram of another exemplary transmission according to the principles of the present invention;

FIG. 6F is a schematic lever diagram of another exemplary transmission according to the principles of the present invention;

FIG. 7A is a diagrammatic illustration of an embodiment of a transmission according to the principles of the present invention;

FIG. 7B is a diagrammatic illustration of another embodiment of a transmission according to the principles of the present invention;

FIG. 7C is a diagrammatic illustration of another embodiment of a transmission according to the principles of the present invention;

FIG. 7D is a diagrammatic illustration of another embodiment of a transmission according to the principles of the present invention;

FIG. 7E is a diagrammatic illustration of another embodiment of a transmission according to the principles of the present invention;

FIG. 7F is a diagrammatic illustration of another embodiment of a transmission according to the principles of the present invention;

FIG. 8A is a schematic lever diagram of an exemplary transmission according to the principles of the present invention;

FIG. 8B is a schematic lever diagram of another exemplary transmission according to the principles of the present invention;

FIG. 8C is a schematic lever diagram of another exemplary transmission according to the principles of the present invention;

FIG. 8D is a schematic lever diagram of another exemplary transmission according to the principles of the present invention;

FIG. 8E is a schematic lever diagram of another exemplary transmission according to the principles of the present invention;

FIG. 8F is a schematic lever diagram of another exemplary transmission according to the principles of the present invention;

FIG. 9A is a diagrammatic illustration of an embodiment of a transmission according to the principles of the present invention;

FIG. 9B is a diagrammatic illustration of another embodiment of a transmission according to the principles of the present invention;

FIG. 9C is a diagrammatic illustration of another embodiment of a transmission according to the principles of the present invention;

FIG. 9D is a diagrammatic illustration of another embodiment of a transmission according to the principles of the present invention;

FIG. 9E is a diagrammatic illustration of another embodiment of a transmission according to the principles of the present invention; and

FIG. 9F is a diagrammatic illustration of another embodiment of a transmission according to the principles of the present invention.

### DETAILED DESCRIPTION

The following description is merely exemplary in nature and is not intended to limit the present disclosure, application, or uses.

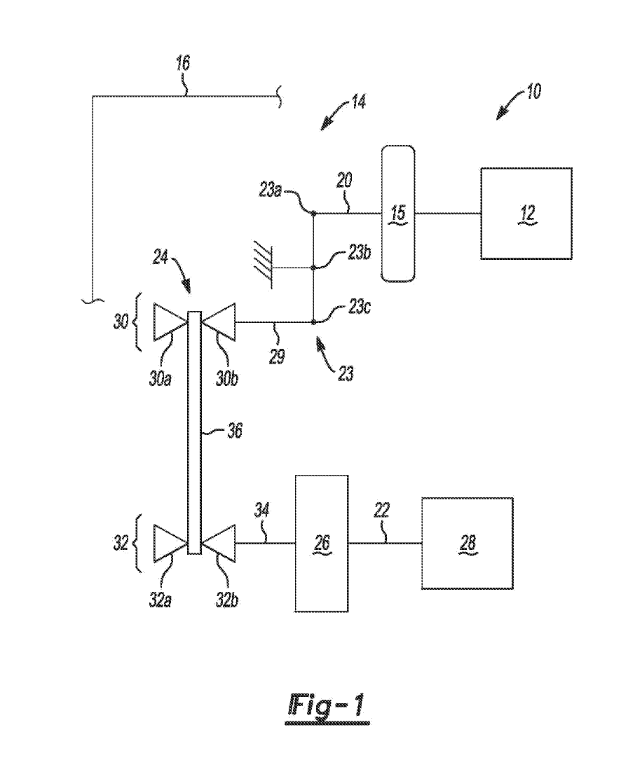

With reference to FIG. 1, a powertrain for a motor vehicle is generally indicated by reference number 10. The powertrain 10 generally includes an engine 12 interconnected with a transmission 14. The engine 12 may be a conventional gasoline, Diesel, or flex fuel internal combustion engine, a hybrid engine, or an electric motor, or any other type of prime mover, without departing from the scope of the present disclosure. The engine 12 supplies a driving torque to the transmission 14 through, for example, a flexplate (not shown) or other connecting device or a starting device 15 such as a hydrodynamic device or launch clutch.

The transmission 14 is a variable diameter pulley or sheave drive continuously variable transmission (CVT). The transmission 14 includes a typically cast, metal housing 16 which encloses and protects the various components of the transmission 14. The housing 16 includes a variety of apertures, passageways, shoulders and flanges which position and support these components. Generally speaking, the transmission 14 includes a transmission input shaft 20 and a transmission output shaft 22. Connected between the transmission input shaft 20 and the transmission output shaft 22 is a transfer gear set 23, a pulley assembly 24, and a gearbox 26 that cooperate to provide forward and reverse speed or gear ratios between the transmission input shaft 20 and the transmission output shaft 22. The transmission input shaft 20 is functionally interconnected with the engine 12 through the starting device 15 and receives input torque or power from the engine 12. The transmission output shaft 22 is preferably connected with a final drive unit 28. The transmission output shaft 22 provides drive torque to the final drive unit 28. The final drive 28 unit may include a differential, axle shafts, and road wheels (not shown).

The transmission input shaft 20 is connected to the transfer gear set 23. The transfer gear set 23, as well as the various gearbox 26 arrangements described below, are illustrated in a lever diagram format. A lever diagram is a schematic representation of the components of a mechanical device such as meshing gear sets or planetary gear sets. Each individual lever represents a planetary gear set or meshed gear pair. The three basic mechanical components of the planetary gear are each represented by a node while the gear pairs are represented by a node and the rotation change represented by a node fixed to ground. Therefore, a single lever contains three nodes. In a planetary gear set, one node represents the sun gear, one the planet gear carrier, and one the ring gear. In a meshed gear pair, one node represents a first gear, one a second gear, and the third the rotational direction change between the meshed gears. In some cases, two levers may be combined into a single lever having more than three nodes (typically four nodes). For example, if two nodes on two different levers are interconnected through a fixed connection they may be represented as a single node on a single lever. The relative length between the nodes of each lever can be used to represent the ring-to-sun ratio of each respective gear set. These lever ratios, in turn, are used to vary the gear ratios of the transmission in order to achieve an appropriate ratios and ratio progression. Mechanical couplings or interconnections between the nodes of the various planetary gear sets are illustrated by thin, horizontal lines and torque transmitting devices such as clutches and brakes are presented as interleaved fingers. Further explanation of the format, purpose and use of lever diagrams can be found in SAE Paper 810102, “The Lever Analogy: A New Tool in Transmission Analysis” by Benford and Leising which is hereby fully incorporated by reference.

For example, the transfer gear set 23 includes a first node 23A, a second node 23B, and a third node 23C. The first node 23A is coupled to the transmission input shaft 20. The second node 23B is fixed to ground representing a change in rotational direction. The third node 23C is coupled to a first transfer shaft or rotating member 29 that is connected to the pulley assembly 24. The first node 23A preferably represents a first gear while the third node 23C preferably represents a second gear meshed with the first gear. The gears may be co-planar or partially axially offset. In a preferred embodiment, the transfer gear set 23 is an overdrive transfer gear set 23 that increases the speed of the first transfer shaft 29 relative to the transmission input 20 while decreasing the torque. In a second preferred embodiment, the transfer gear set 23 is an underdrive transfer gear set 23. In a third preferred embodiment, the transfer gear set 23 acts as a direct drive coupling member with no relative speed change.

The pulley assembly 24 includes a first pulley or sheave pair 30 and a second pulley or sheave pair 32. The first pulley 30 includes a first truncated conical sheave or member 30A and second truncated conical sheave or member 30B in axial alignment with the first truncated conical sheave 30A. The second sheave 30B is directly connected for rotation with the first transfer member 29 and may be integrally formed with the first transfer member 29. The first sheave 30A is moveable axially relative to the second sheave 30B by a hydraulic control system (not shown) or other actuating system. It should be appreciated that the sheaves 30A and 30B may be axially switched without departing from the scope of the present invention.

The second pulley 32 includes a first truncated conical sheave or member 32A and second truncated conical sheave or member 32B in axial alignment with the first truncated conical sheave 32A. The second sheave 32B is directly connected for rotation with a second transfer shaft or member 34 or may be integrally formed with the second transfer shaft 34. The first sheave 32A is moveable axially relative to the second sheave 32B by a hydraulic control system (not shown) or other actuating system. It should be appreciated that the sheaves 32A and 32B may be axially switched without departing from the scope of the present invention.

A torque transmitting belt or chain 36 having a V-shaped cross section is mounted between the first pulley pair 30 and the second pulley pair 32. It should be appreciated that other types of belts, including positive engagement devices, may be employed without departing from the scope of the present invention. Drive torque communicated from the transmission input shaft 20 is transferred via friction between the sheaves 30A and 30B and the belt 36. The ratio of the input pulley 30 to the output pulley 32 is adjusted by varying the spacing between the sheaves 30A and 30B and between the sheaves 32A and 32B. For example, to change the ratio between the pulleys 30 and 32, the axial distance between sheaves 30A and 30B may be reduced by moving sheave 30A towards sheave 32B while simultaneously the axial distance between sheave 32A and 32B may be increased by moving sheave 32A away from sheave 32B. Due to the V-shaped cross section of the belt 36, the belt 36 rides higher on the first pulley 30 and lower on the second pulley 32. Therefore the effective diameters of the pulleys 30 and 32 change, which in turn changes the overall gear ratio between the first pulley 30 and the second pulley 32. Since the radial distance between the pulleys 30 and 32 and the length of the belt 36 is constant, the movement of the sheaves 30A and 32A must occur simultaneously in order to maintain the proper amount of tension on the belt 36 to assure torque is transferred from the pulleys 30, 32 to the belt 36.

The pulley assembly 24 transfers torque to the gearbox 26 via the second transfer shaft 34. The gearbox 26 comprises one of several planetary gear set transmissions or arrangements, as will be described in greater detail below. The gearbox 26 outputs torque from the pulley assembly 26 to the transmission output shaft 22 and then to the final drive unit 28.

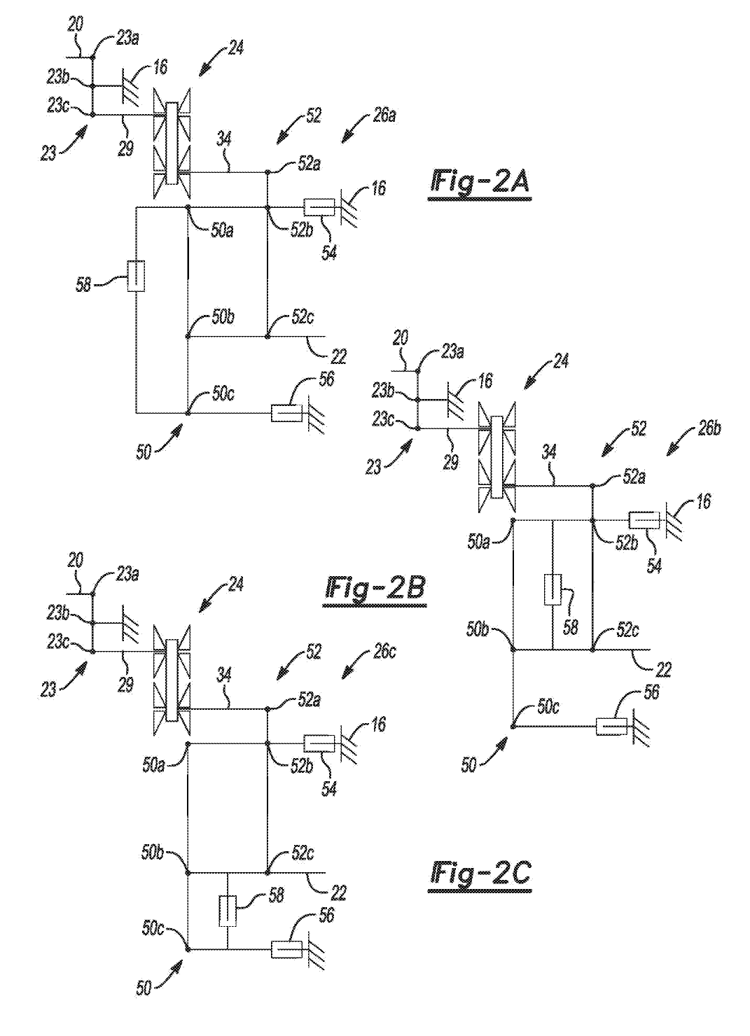

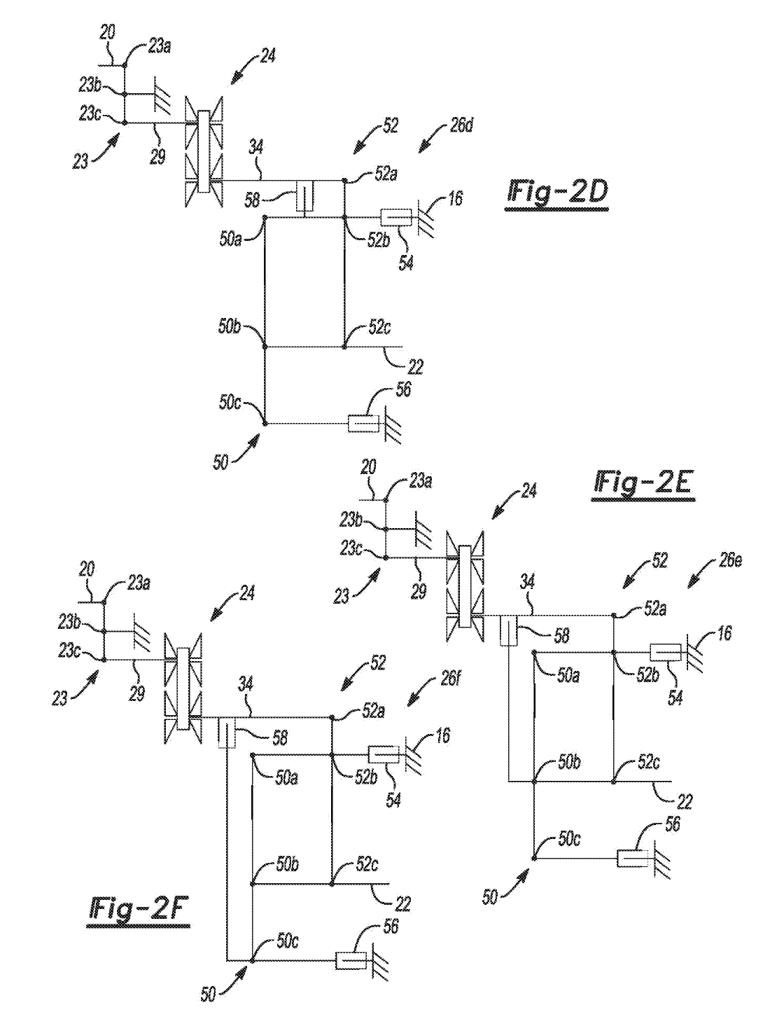

Turning now to FIGS. 2A-F, various configurations of the gearbox 26 are shown in lever diagram format. The gearboxes illustrated in FIGS. 2A-F include specific types of transmissions known as Ravigneaux, powerglide, and ring-carrier and ring-carrier levers, as will be described below. The gearbox 26 includes a first planetary gear set 50 and a second planetary gear set 52. The first planetary gear set 50 has three nodes: a first node 50A, a second node 50B and a third node 50C. The second planetary gear set 52 has three nodes: a first node 52A, a second node 52B and a third node 52C.

The second transfer member 34 is continuously coupled to the first node 52A of the second planetary gear set 52. The transmission output member 22 is coupled to the third node 52C of the second planetary gear set 52. The first node 50A of the first planetary gear set 50 is coupled to the second node 52B of the second planetary gear set 52. The second node 50B of the first planetary gear set 50 is coupled to the third node 52C of the second planetary gear set 52.

A first brake 54 selectively connects the second node 52B of the second planetary gear set 52 and the first node 50A of the first planetary gear set 50 with a stationary element or transmission housing 16. A second brake 56 selectively connects the third node 50C of the first planetary gear set 50 with the stationary element or transmission housing 16. A first clutch 58 selectively connects the first node 50A of the first planetary gear set 50 and the second node 52B of the second planetary gear set 52 with the third node 50C of the first planetary gear set 50.

With reference to FIG. 2B, an alternate gearbox arrangement 26B is shown. The gearbox 26B is similar to that shown in FIG. 2A and therefore like components are indicated by like reference numbers. However, in FIG. 2B, the first clutch 58 is relocated and selectively connects the first node 50A of the first planetary gear set 50 and the second node 52B of the second planetary gear set 52 with the second node 50B of the first planetary gear set 50 and the third node 52C of the second planetary gear set 52.

With reference to FIG. 2C, an alternate gearbox arrangement 26C is shown. The gearbox 26C is similar to that shown in FIG. 2A and therefore like components are indicated by like reference numbers. However, in FIG. 2C, the first clutch 58 is relocated and selectively connects the second node 50B of the first planetary gear set 50 and the third node 52C of the second planetary gear set 52 with the third node 50C of the first planetary gear set 50.

With reference to FIG. 2D, an alternate gearbox arrangement 26D is shown. The gearbox 26D is similar to that shown in FIG. 2A and therefore like components are indicated by like reference numbers. However, in FIG. 2D, the first clutch 58 is relocated and selectively connects the first node 50A of the first planetary gear set 50 and the second node 52B of the second planetary gear set 52 with the first node 52A of the second planetary gear set 52.

With reference to FIG. 2E, an alternate gearbox arrangement 26E is shown. The gearbox 26E is similar to that shown in FIG. 2A and therefore like components are indicated by like reference numbers. However, in FIG. 2E, the first clutch 58 is relocated and selectively connects the second node 50B of the first planetary gear set 50 and the third node 52C of the second planetary gear set 52 with the first node 52A of the second planetary gear set 52.

With reference to FIG. 2F, an alternate gearbox arrangement 26F is shown. The gearbox 26F is similar to that shown in FIG. 2A and therefore like components are indicated by like reference numbers. However, in FIG. 2F, the first clutch 58 is relocated and selectively connects the first node 52A of the second planetary gear set 52 with the third node 50C of the first planetary gear set 50.

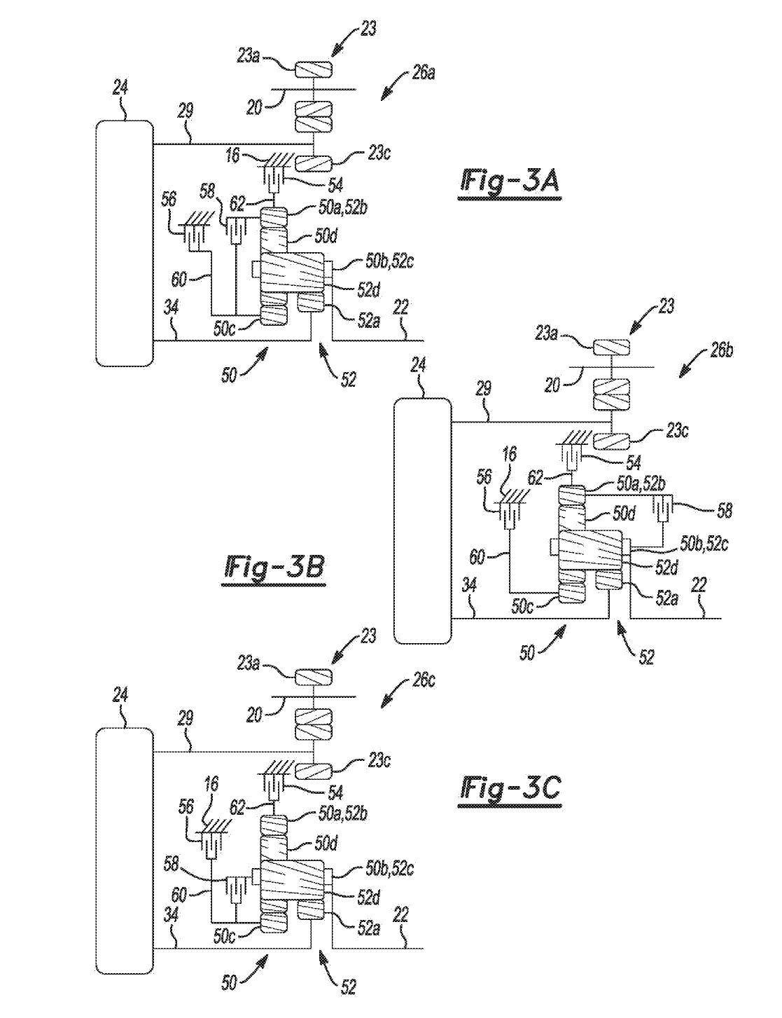

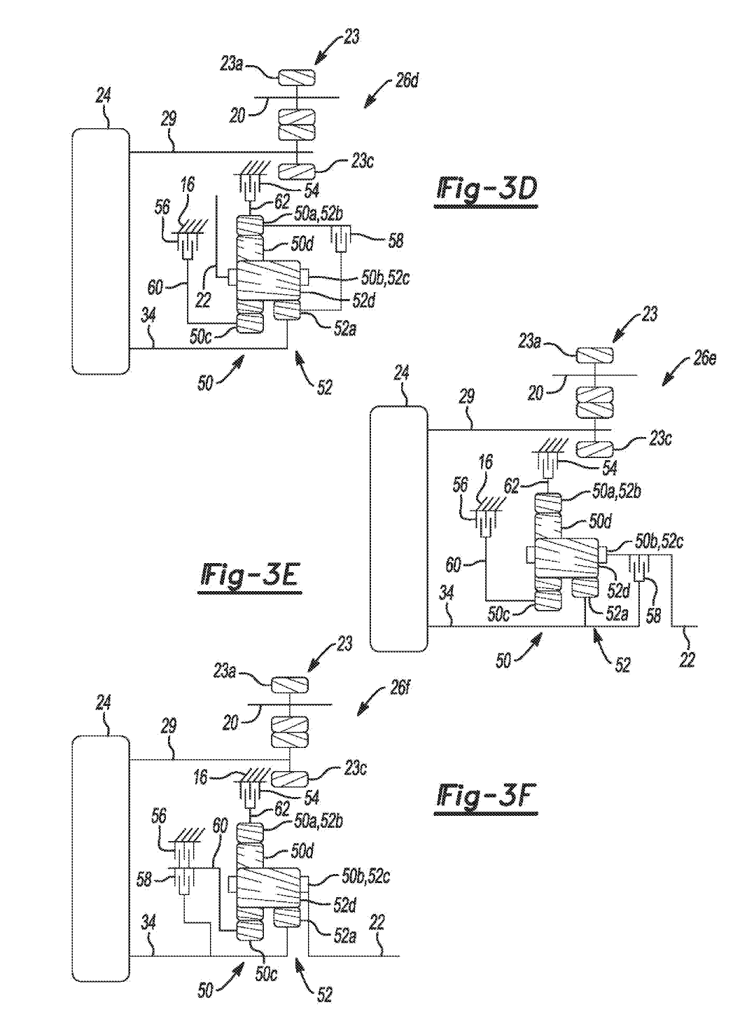

Turning now to FIGS. 3A-F stick diagrams present schematic layouts of embodiments of the gearbox 26, 26B-F according to the present invention. In FIGS. 3A-F the numbering from the lever diagram of FIGS. 2A-F are carried over. The clutches and couplings are correspondingly presented whereas the nodes of the planetary gear sets now appear as components of planetary gear sets such as sun gears, ring gears, planet gears and planet gear carriers.

For example, the transfer gear set 23 includes a first gear 23A meshed with a second gear 23C while the gear sets 50 and 52 include a common planet carrier member 50B/52C, a ring gear member 50A, a sun gear member 50C, and a sun gear member 52A. It should be appreciated that ring gear member 52B is optional and not shown. The common planet carrier member 50B/52C rotatably supports a set of planet gears 50D (only one of which is shown) and 52D (only one of which is shown). The planet gears 50D are each configured to intermesh with the ring gear member 50A while the planet gears 52D are long pinions that each intermesh with both the planet gears 50D and the sun gear member 52A. The sun gear member 50C is connected for common rotation with a first shaft or interconnecting member 60. The sun gear member 52A is connected for common rotation with the second transfer member 34. The planet carrier member 50B/52C is connected for common rotation with the transmission output shaft 22. The ring gear member 50A is connected for common rotation with a second shaft or interconnecting member 62.

The torque-transmitting mechanisms or brakes 54, 56 and clutch 58 allow for selective interconnection of the shafts or interconnecting members, members of the planetary gear sets and the housing. The torque-transmitting mechanisms are friction, dog or synchronizer type mechanisms or the like. For example, the first brake 54 is selectively engageable to connect the second shaft or interconnecting member 62 with the transmission housing 14 in order to restrict relative rotation of the member 62 and therefore the ring gear member 50A. The second brake 56 is selectively engageable to connect the first shaft or interconnecting member 60 with the transmission housing 14 in order to restrict relative rotation of the member 60 and therefore the sun gear member 50C. In FIG. 3A, the clutch 58 is selectively engageable to connect the ring gear member 50A with the sun gear member 50C.

Likewise, FIGS. 3B-3F illustrate stick diagrams of the corresponding gearbox arrangements 26B-26F which alter the location of the clutch 58, as described above. With reference to FIG. 3B, an alternate gearbox arrangement 26B is shown. The gearbox 26B is similar to that shown in FIG. 3A and therefore like components are indicated by like reference numbers. However, in FIG. 3B, the first clutch 58 is relocated and selectively connects the ring gear 50A with the carrier member 50B/52C.

With reference to FIG. 3C, an alternate gearbox arrangement 26C is shown. The gearbox 26C is similar to that shown in FIG. 3A and therefore like components are indicated by like reference numbers. However, in FIG. 3C, the first clutch 58 is relocated and selectively connects the carrier member 50B/52C with the sun gear 50C of the first planetary gear set 50.

With reference to FIG. 3D, an alternate gearbox arrangement 26D is shown. The gearbox 26D is similar to that shown in FIG. 3A and therefore like components are indicated by like reference numbers. However, in FIG. 3D, the first clutch 58 is relocated and selectively connects the ring gear 50A with the sun gear 52A of the second planetary gear set 52.

With reference to FIG. 3E, an alternate gearbox arrangement 26E is shown. The gearbox 26E is similar to that shown in FIG. 3A and therefore like components are indicated by like reference numbers. However, in FIG. 3E, the first clutch 58 is relocated and selectively connects the carrier member 50B/52C with the sun gear 52A of the second planetary gear set 52.

With reference to FIG. 3F, an alternate gearbox arrangement 26F is shown. The gearbox 26F is similar to that shown in FIG. 3A and therefore like components are indicated by like reference numbers. However, in FIG. 3F, the first clutch 58 is relocated and selectively connects the sun gear 52A of the second planetary gear set 52 with the sun gear 50C of the first planetary gear set 50.

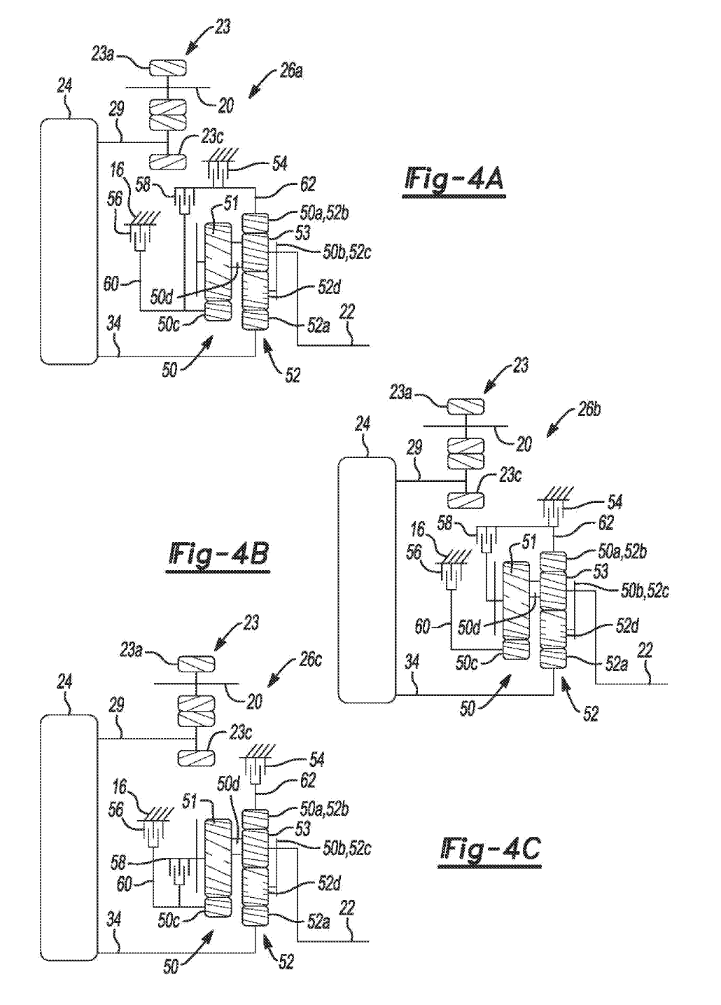

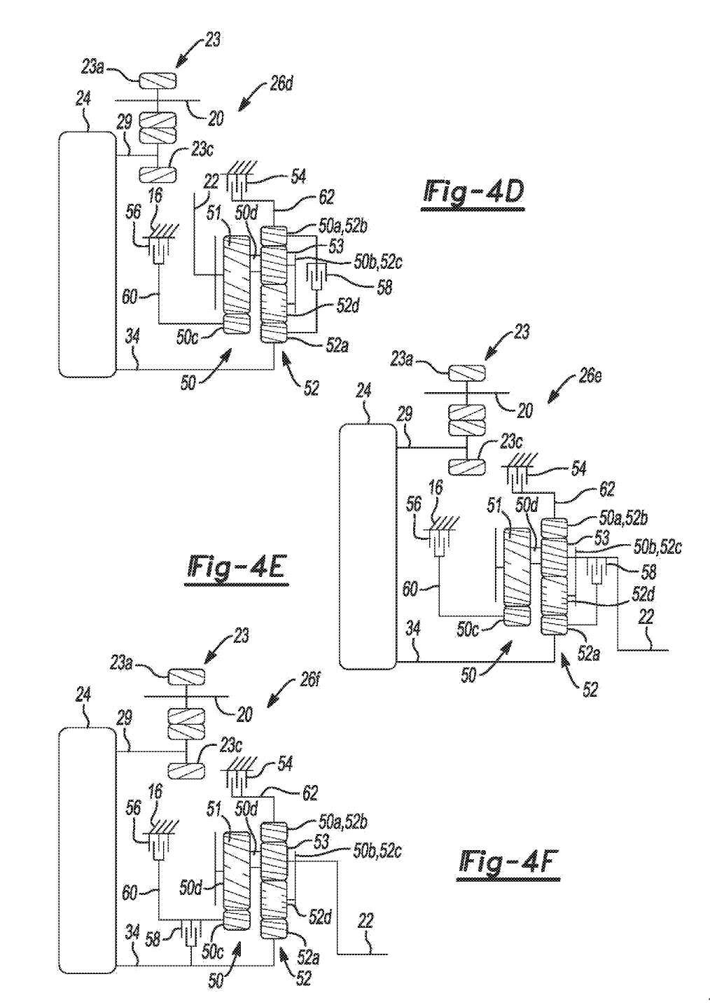

Turning now to FIGS. 4A-F stick diagrams present schematic layouts of Ravigneaux type embodiments of the gearbox 26, 26B-F according to the present invention. In FIGS. 4A-F the numbering from the lever diagram of FIGS. 2A-F are carried over. The clutches and couplings are correspondingly presented whereas the nodes of the planetary gear sets now appear as components of planetary gear sets such as sun gears, ring gears, planet gears and planet gear carriers.

For example, the planetary gear set 50 is configured as a simple planetary gear set while planetary gear set 52 is a compound planetary gear set. These gear sets are connected either as separate gear sets or as a single planetary gear set arrangement. The gear sets 50 and 52 include a common planet carrier member 50B/52C, a common ring gear member 50A/52B, a sun gear member 50C, and a sun gear member 52A. The common planet carrier member 50B/52C rotatably supports a set of planet gears 50D (only one of which is shown) and 52D (only one of which is shown). The planet gears 50D are stepped pinions having a first stepped portion 51 and a second stepped portion 53. The stepped portions 51 of the planet gears 50D are each configured to intermesh with sun gears 50C. The stepped portions 53 of the planet gears 50D are each configured to intermesh with both the ring gear member 50A/52B and the non-stepped pinions 52D. The planet gears 52D each intermesh with both the stepped portions 53 of the planet gears 50D and the sun gear member 52A. The sun gear member 50C is connected for common rotation with a first shaft or interconnecting member 60. The sun gear member 52A is connected for common rotation with the transfer member 34. The planet carrier member 50B/52C is connected for common rotation with the transmission output shaft 22. The ring gear member 50A/52B is connected for common rotation with a second shaft or interconnecting member 62.

The first brake 54 is selectively engageable to connect the second shaft or interconnecting member 62 with the transmission housing 14 in order to restrict relative rotation of the member 62 and therefore the ring gear member 50A/52B. The second brake 56 is selectively engageable to connect the first shaft or interconnecting member 60 with the transmission housing 14 in order to restrict relative rotation of the member 60 and therefore the sun gear member 50C. In FIG. 4A, the clutch 58 is selectively engageable to connect the ring gear member 50A/52B with the sun gear member 50C.

Likewise, FIGS. 4B-4F illustrate stick diagrams of the corresponding gearbox arrangements 26B-26F which alter the location of the clutch 58, as described above. With reference to FIG. 4B, an alternate gearbox arrangement 26B is shown. The gearbox 26B is similar to that shown in FIG. 4A and therefore like components are indicated by like reference numbers. However, in FIG. 4B, the first clutch 58 is relocated and selectively connects the ring gear 50A/52B with the carrier member 50B/52C.

With reference to FIG. 4C, an alternate gearbox arrangement 26C is shown. The gearbox 26C is similar to that shown in FIG. 4A and therefore like components are indicated by like reference numbers. However, in FIG. 4C, the first clutch 58 is relocated and selectively connects the carrier member 50B/52C with the sun gear 50C of the first planetary gear set 50.

With reference to FIG. 4D, an alternate gearbox arrangement 26D is shown. The gearbox 26D is similar to that shown in FIG. 4A and therefore like components are indicated by like reference numbers. However, in FIG. 4D, the first clutch 58 is relocated and selectively connects the ring gear 50A/52B with the sun gear 52A of the second planetary gear set 52.

With reference to FIG. 4E, an alternate gearbox arrangement 26E is shown. The gearbox 26E is similar to that shown in FIG. 4A and therefore like components are indicated by like reference numbers. However, in FIG. 4E, the first clutch 58 is relocated and selectively connects the carrier member 50B/52C with the sun gear 52A of the second planetary gear set 52.

With reference to FIG. 4F, an alternate gearbox arrangement 26F is shown. The gearbox 26F is similar to that shown in FIG. 4A and therefore like components are indicated by like reference numbers. However, in FIG. 4F, the first clutch 58 is relocated and selectively connects the sun gear 52A of the second planetary gear set 52 with the sun gear 50C of the first planetary gear set 50.

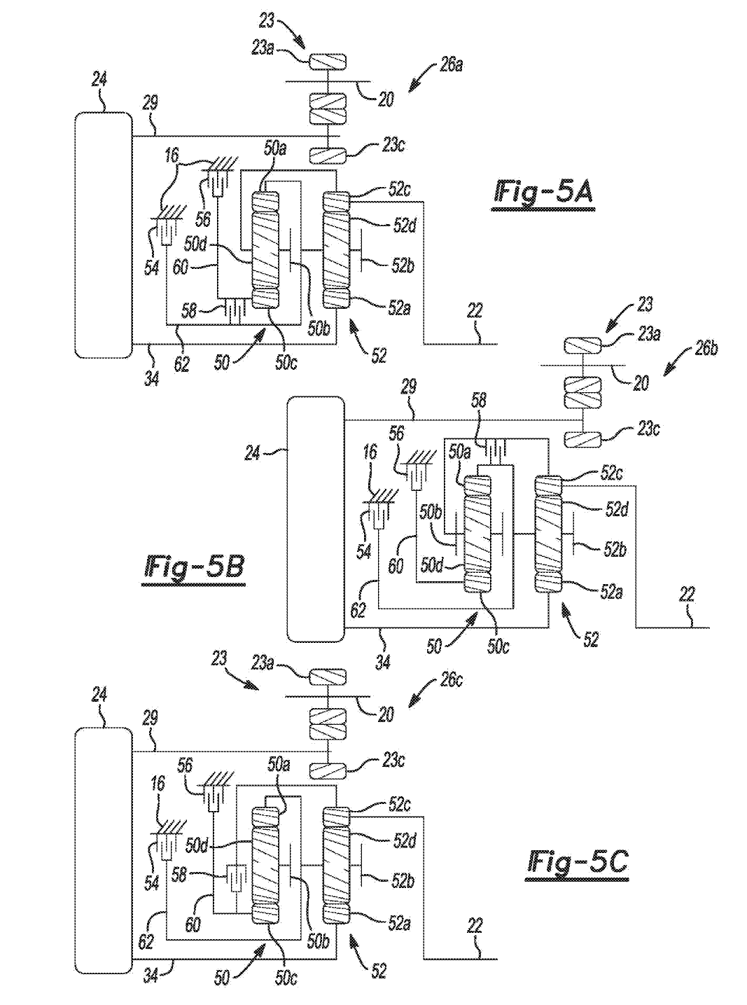

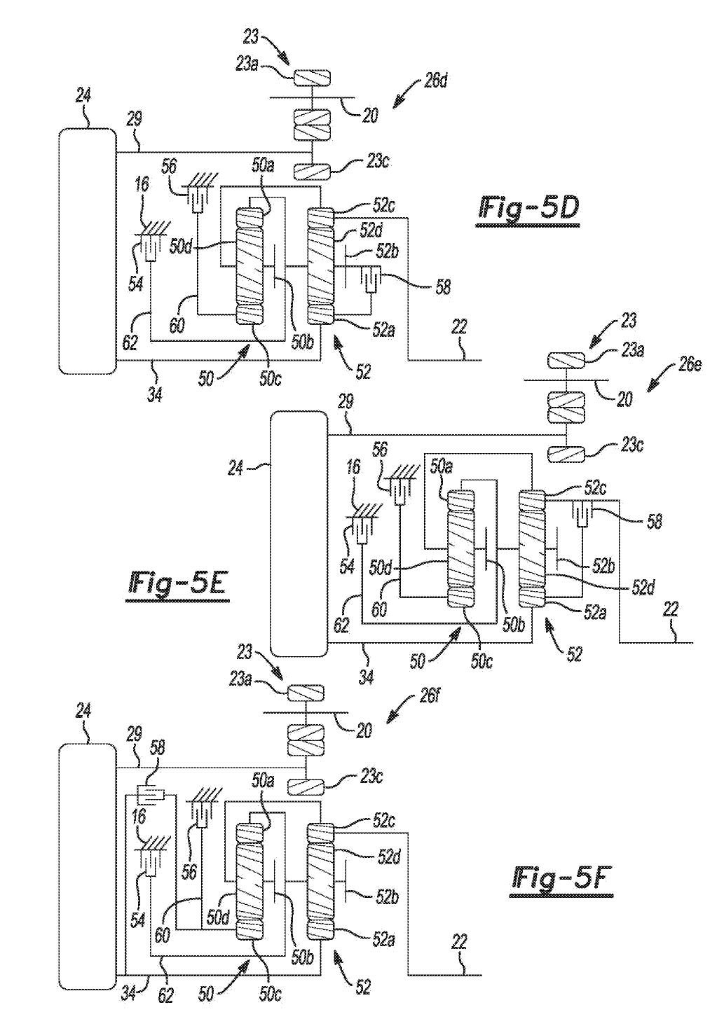

Turning now to FIGS. 5A-F stick diagrams present schematic layouts of embodiments of the gearbox 26, 26B-F according to the present invention. In FIGS. 5A-F the numbering from the lever diagram of FIGS. 2A-F are carried over. The clutches and couplings are correspondingly presented whereas the nodes of the planetary gear sets now appear as components of planetary gear sets such as sun gears, ring gears, planet gears and planet gear carriers.

For example, the planetary gear set 50 includes a sun gear member 50C, a ring gear member 50A, and a planet carrier member 50B that rotatable supports a set of planet gears 50D (only one of which is shown). The planet gears 50D are each configured to intermesh with both the sun gear member 50C and the ring gear member 50A. The sun gear member 50C is connected for common rotation with the first shaft or interconnecting member 60. The ring gear member 50A is connected for common rotation with the second shaft or interconnecting member 62. The planet carrier member 50B is connected for common rotation with the transmission output shaft 22.

The planetary gear set 52 includes a sun gear member 52A, a ring gear member 52C, and a planet carrier member 52B that rotatable supports a set of planet gears 52D (only one of which is shown). The planet gears 52D are each configured to intermesh with both the sun gear member 52A and the ring gear member 52C. The sun gear member 52A is connected for common rotation with the transfer member 34. The ring gear member 52C is connected for common rotation with the transmission output member 22. The planet carrier member 52B is connected for common rotation with the second interconnecting member 62.

The first brake 54 is selectively engageable to connect the second shaft or interconnecting member 62 with the transmission housing 14 in order to restrict relative rotation of the member 62 and therefore the ring gear member 50A and the carrier member 52B. The second brake 56 is selectively engageable to connect the first shaft or interconnecting member 60 with the transmission housing 14 in order to restrict relative rotation of the member 60 and therefore the sun gear member 50C. In FIG. 5A, the clutch 58 is selectively engageable to connect the ring gear member 50A and the carrier member 52B with the sun gear member 50C.

Likewise, FIGS. 5B-4F illustrate stick diagrams of the corresponding gearbox arrangements 26B-26F which alter the location of the clutch 58, as described above. With reference to FIG. 5B, an alternate gearbox arrangement 26B is shown. The gearbox 26B is similar to that shown in FIG. 5A and therefore like components are indicated by like reference numbers. However, in FIG. 5B, the first clutch 58 is relocated and selectively connects the ring gear 50A and carrier member 52B with the carrier member 50B and the ring gear 52C.

With reference to FIG. 5C, an alternate gearbox arrangement 26C is shown. The gearbox 26C is similar to that shown in FIG. 5A and therefore like components are indicated by like reference numbers. However, in FIG. 5C, the first clutch 58 is relocated and selectively connects the carrier member 50B and the ring gear 52C with the sun gear 50C of the first planetary gear set 50.

With reference to FIG. 5D, an alternate gearbox arrangement 26D is shown. The gearbox 26D is similar to that shown in FIG. 5A and therefore like components are indicated by like reference numbers. However, in FIG. 5D, the first clutch 58 is relocated and selectively connects the ring gear 50A and the carrier member 52B with the sun gear 52A of the second planetary gear set 52.

With reference to FIG. 5E, an alternate gearbox arrangement 26E is shown. The gearbox 26E is similar to that shown in FIG. 5A and therefore like components are indicated by like reference numbers. However, in FIG. 5E, the first clutch 58 is relocated and selectively connects the carrier member 50B and ring gear 52C with the sun gear 52A of the second planetary gear set 52.

With reference to FIG. 5F, an alternate gearbox arrangement 26F is shown. The gearbox 26F is similar to that shown in FIG. 5A and therefore like components are indicated by like reference numbers. However, in FIG. 5F, the first clutch 58 is relocated and selectively connects the sun gear 52A of the second planetary gear set 52 with the sun gear 50C of the first planetary gear set 50.

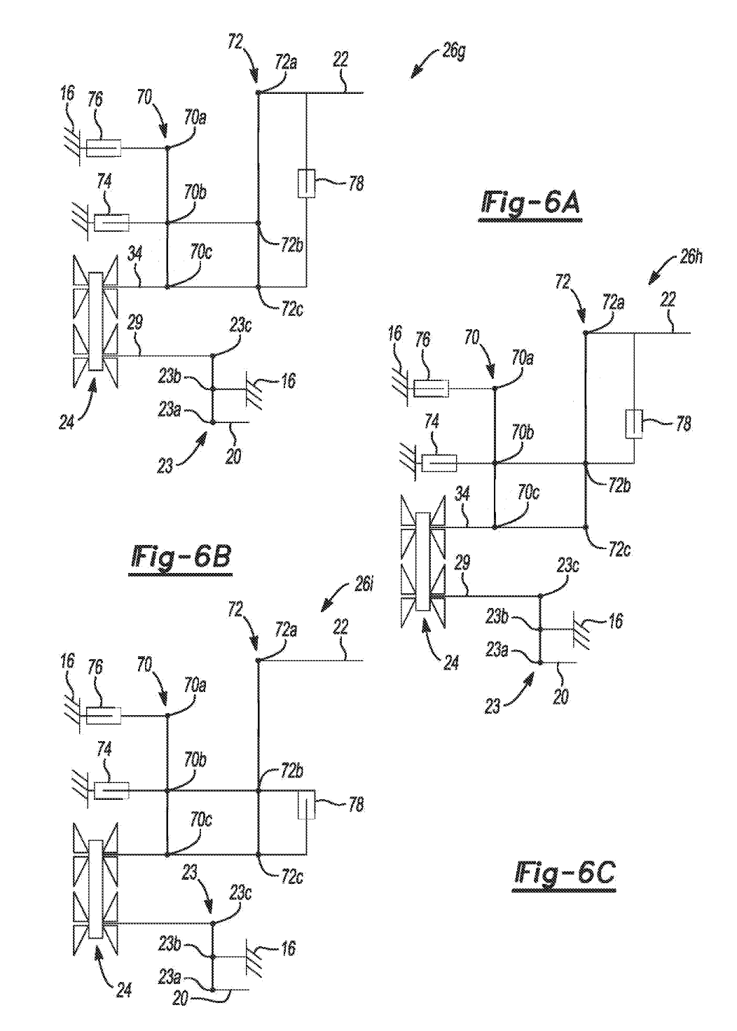

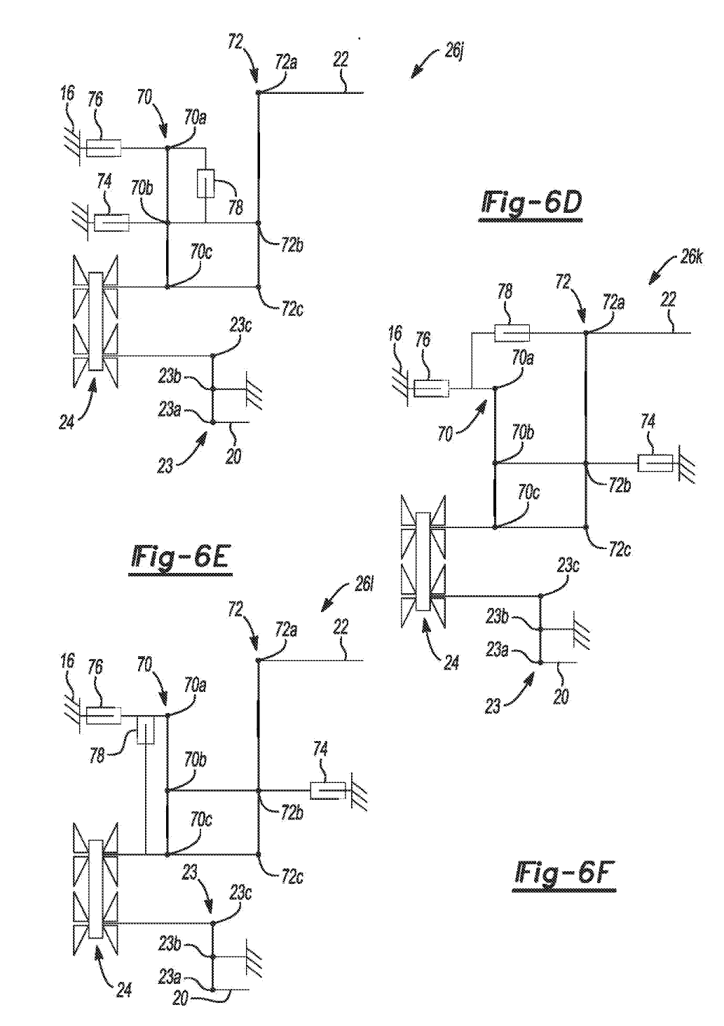

Turning now to FIGS. 6A-F, another set of configurations of the gearbox 26 are shown in lever diagram format. The gearboxes illustrated in FIGS. 6A-F include specific types of transmissions known as stacked planetary gear sets, as will be described below. For example, the gearbox 26G includes a first planetary gear set 70 and a second planetary gear set 72. The first planetary gear set 70 has three nodes: a first node 70A, a second node 70B and a third node 70C. The second planetary gear set 72 has three nodes: a first node 72A, a second node 72B and a third node 72C.

The transfer member 34 is continuously coupled to the third node 70C of the first planetary gear set 70 or to the third node 72C of the second planetary gear set 72. The transmission output member 22 is coupled to the first node 72A of the second planetary gear set 72. The second node 70B of the first planetary gear set 70 is coupled to the second node 72B of the second planetary gear set 72. The third node 70C of the first planetary gear set 70 is coupled to the third node 72C of the second planetary gear set 72.

A first brake 74 selectively connects the second node 70B of the first planetary gear set 70 and the second node 72B of the second planetary gear set 72 with a stationary member or transmission housing 14. A second brake 76 selectively connects the first node 70A of the first planetary gear set 70 with the stationary member or transmission housing 14. A first clutch 78 selectively connects the third node 70C of the first planetary gear set 70 and the third node 72C of the second planetary gear set 72 with the first node 72A of the second planetary gear set 72 and the transmission output member 22.

With reference to FIG. 6B, an alternate gearbox arrangement 26H is shown. The gearbox 26H is similar to that shown in FIG. 6A and therefore like components are indicated by like reference numbers. However, in FIG. 6B, the first clutch 78 is relocated and selectively connects the second node 70B of the first planetary gear set 70 and the second node 72B of the second planetary gear set 72 with the first node 72A of the second planetary gear set 72 and the transmission output member 22

With reference to FIG. 6C, an alternate gearbox arrangement 26I is shown. The gearbox 26I is similar to that shown in FIG. 6A and therefore like components are indicated by like reference numbers. However, in FIG. 6C, the first clutch 78 is relocated and selectively the second node 70B of the first planetary gear set 70 and the second node 72B of the second planetary gear set 72 with the third node 70C of the first planetary gear set 70 and the third node 72C of the second planetary gear set 72.

With reference to FIG. 6D, an alternate gearbox arrangement 26J is shown. The gearbox 26J is similar to that shown in FIG. 6A and therefore like components are indicated by like reference numbers. However, in FIG. 6D, the first clutch 78 is relocated and selectively connects the second node 70B of the first planetary gear set 70 and the second node 72B of the second planetary gear set 72 with the first node 70A of the first planetary gear set 70.

With reference to FIG. 6E, an alternate gearbox arrangement 26K is shown. The gearbox 26K is similar to that shown in FIG. 6A and therefore like components are indicated by like reference numbers. However, in FIG. 6E, the first clutch 78 is relocated and selectively connects first node 70A of the first planetary gear set 70 with the first node 72A of the second planetary gear set 72.

With reference to FIG. 6F, an alternate gearbox arrangement 26L is shown. The gearbox 26L is similar to that shown in FIG. 6A and therefore like components are indicated by like reference numbers. However, in FIG. 6F, the first clutch 78 is relocated and selectively connects the first node 70A of the first planetary gear set 70 with the third node 70C of the first planetary gear set and the third node 72C of the second planetary gear set 72.

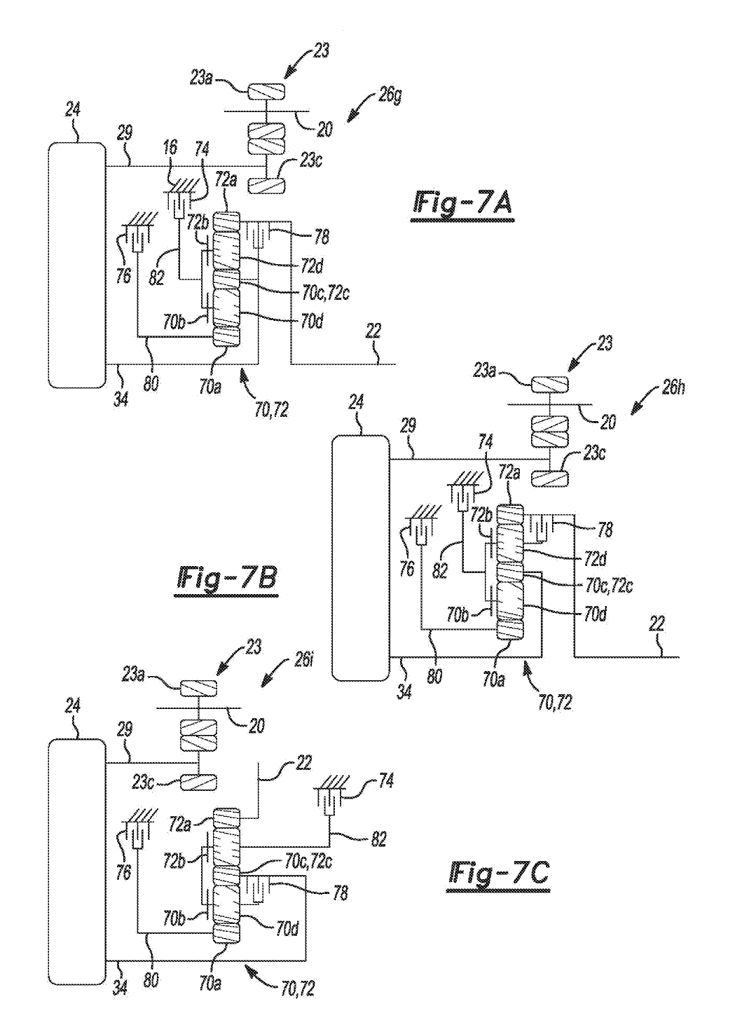

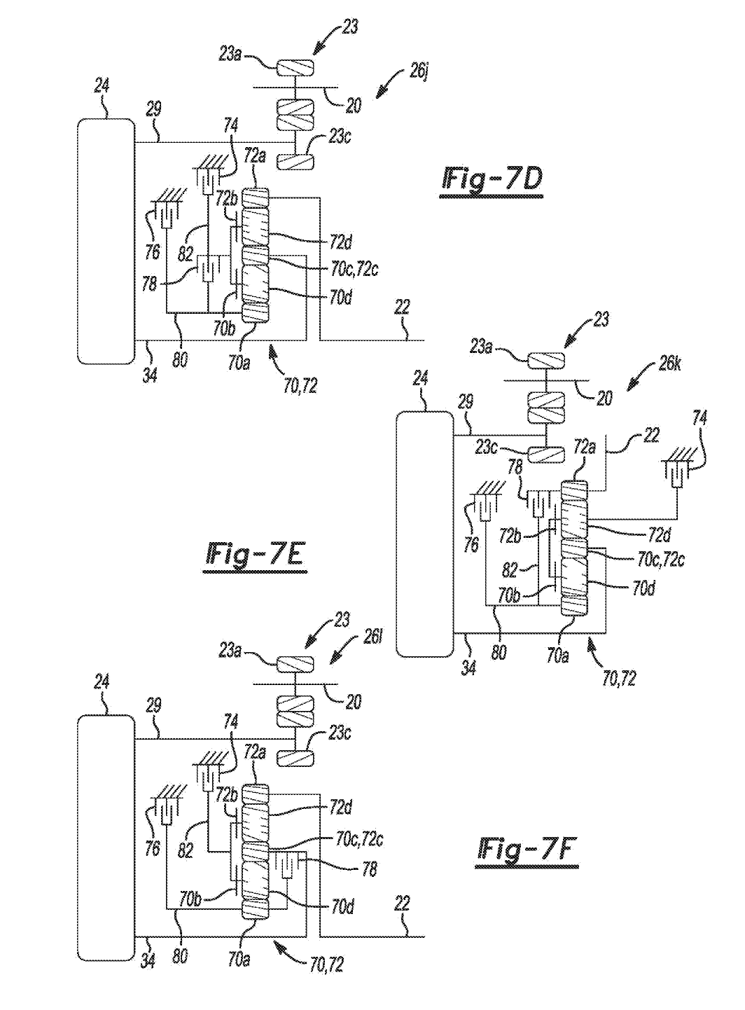

Turning now to FIGS. 7A-F, stick diagrams present schematic layouts of embodiments of the gearbox 26G-L according to the present invention. In FIGS. 7A-F the numbering from the lever diagram of FIGS. 6A-F are carried over. The clutches and couplings are correspondingly presented whereas the nodes of the planetary gear sets now appear as components of planetary gear sets such as sun gears, ring gears, planet gears and planet gear carriers.

For example, the planetary gear set 70 and the planetary gear set 72 are configured as a stacked planetary gear set wherein the first planetary gear set 70 is nested radially inward of the second planetary gear set 72. The planetary gear set 70 includes a sun gear member 70A, a ring gear member 70C, and a planet carrier member 70B that rotatably supports a set of planet gears 70D (only one of which is shown). The planet gears 70D are each configured to intermesh with both the sun gear member 70A and the ring gear member 70C. The sun gear member 70A is connected for common rotation with a first shaft or interconnecting member 80. The ring gear member 70C is connected for common rotation with the transfer member 34. The planet carrier member 70B is connected for common rotation with a second shaft or interconnecting member 82.

The planetary gear set 72 includes a sun gear member 72C, a ring gear member 72A, and a planet carrier member 72B that rotatably supports a set of planet gears 72D (only one of which is shown). The planet gears 72D are each configured to intermesh with both the sun gear member 72C and the ring gear member 72A. The sun gear member 72C is connected for common rotation with the first shaft or interconnecting member 34. The ring gear member 72A is connected for common rotation with the transmission output member 22. The planet carrier member 72B is connected for common rotation with the second shaft or interconnecting member 82. It should be appreciated that the ring gear member 70C of the first planetary gear set 70 and the sun gear member 72C of the second planetary gear set 72 may be formed from a single unitary member having inner and outer gear teeth or from separate gears connected together for rotation.

The torque-transmitting mechanisms or brakes 74, 76 and clutch 78 allow for selective interconnection of the shafts or interconnecting members, members of the planetary gear sets and the housing. The torque-transmitting mechanisms are friction, dog or synchronizer type mechanisms or the like. For example, the first brake 74 is selectively engageable to connect the second shaft or interconnecting member 82 with the transmission housing 14 in order to restrict relative rotation of the member 82 and therefore the carrier member 70B of the first planetary gear set 70 and the carrier member 72B of the second planetary gear set 72. The second brake 76 is selectively engageable to connect the first shaft or interconnecting member 80 with the transmission housing 14 in order to restrict relative rotation of the member 80 and therefore the sun gear member 70A. In FIG. 7A, the clutch 78 is selectively engageable to connect the ring gear member 72A and the transmission output shaft 22 with the transfer shaft 34 and the ring gear member 70C and sun gear member 72C.

Likewise, FIGS. 7B-3F illustrate stick diagrams of the corresponding gearbox arrangements 26H-26L which alter the location of the clutch 78, as described above. With reference to FIG. 7B, an alternate gearbox arrangement 26H is shown. The gearbox 26H is similar to that shown in FIG. 7A and therefore like components are indicated by like reference numbers. However, in FIG. 7B, the first clutch 78 is relocated and selectively connects the carrier member 70B of the first planetary gear set 70 and the carrier member 72B of the second planetary gear set 72 with the ring gear 72A of the second planetary gear set 72 and the transmission output member 22

With reference to FIG. 7C, an alternate gearbox arrangement 26I is shown. The gearbox 26I is similar to that shown in FIG. 7A and therefore like components are indicated by like reference numbers. However, in FIG. 7C, the first clutch 78 is relocated and selectively connects the carrier member 70B of the first planetary gear set 70 and the carrier member 72B of the second planetary gear set 72 with the ring gear 70C of the first planetary gear set 70 and the sun gear 72C of the second planetary gear set 72.

With reference to FIG. 7D, an alternate gearbox arrangement 26J is shown. The gearbox 26J is similar to that shown in FIG. 7A and therefore like components are indicated by like reference numbers. However, in FIG. 7D, the first clutch 78 is relocated and selectively connects the carrier member 70B of the first planetary gear set 70 and the carrier member 72B of the second planetary gear set 72 with the sun gear 70A of the first planetary gear set 70.

With reference to FIG. 7E, an alternate gearbox arrangement 26K is shown. The gearbox 26K is similar to that shown in FIG. 7A and therefore like components are indicated by like reference numbers. However, in FIG. 7E, the first clutch 78 is relocated and selectively connects sun gear 70A of the first planetary gear set 70 with the ring gear 72A of the second planetary gear set 72.

With reference to FIG. 7F, an alternate gearbox arrangement 26L is shown. The gearbox 26L is similar to that shown in FIG. 7A and therefore like components are indicated by like reference numbers. However, in FIG. 7F, the first clutch 78 is relocated and selectively connects the sun gear 70A of the first planetary gear set 70 with the ring gear 70C of the first planetary gear set and the sun gear 72C of the second planetary gear set 72.

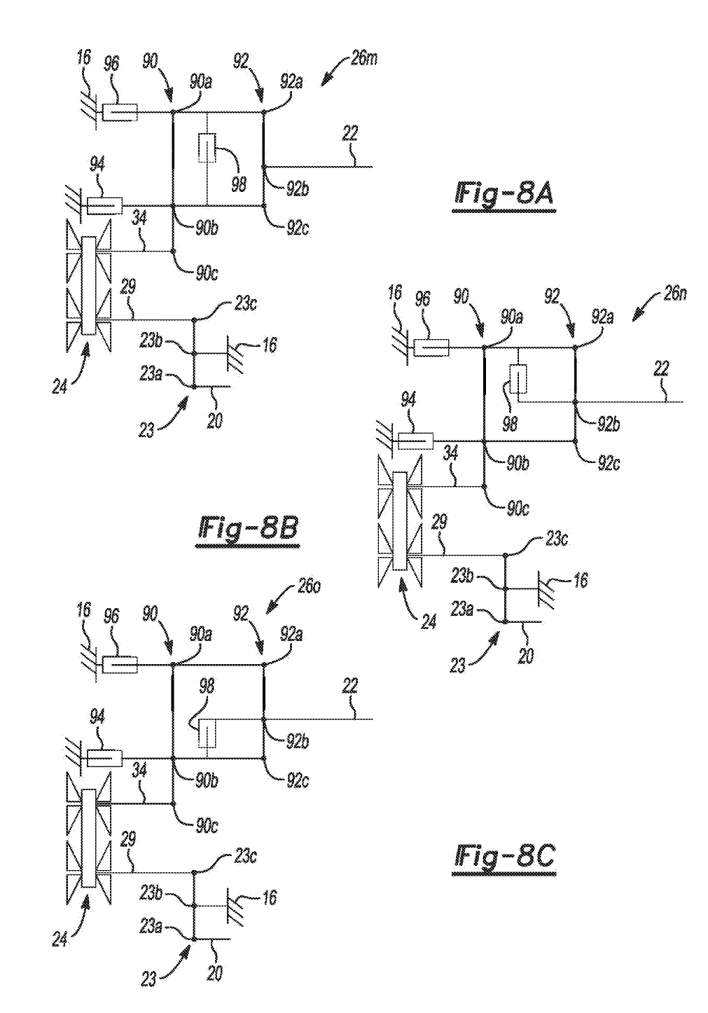

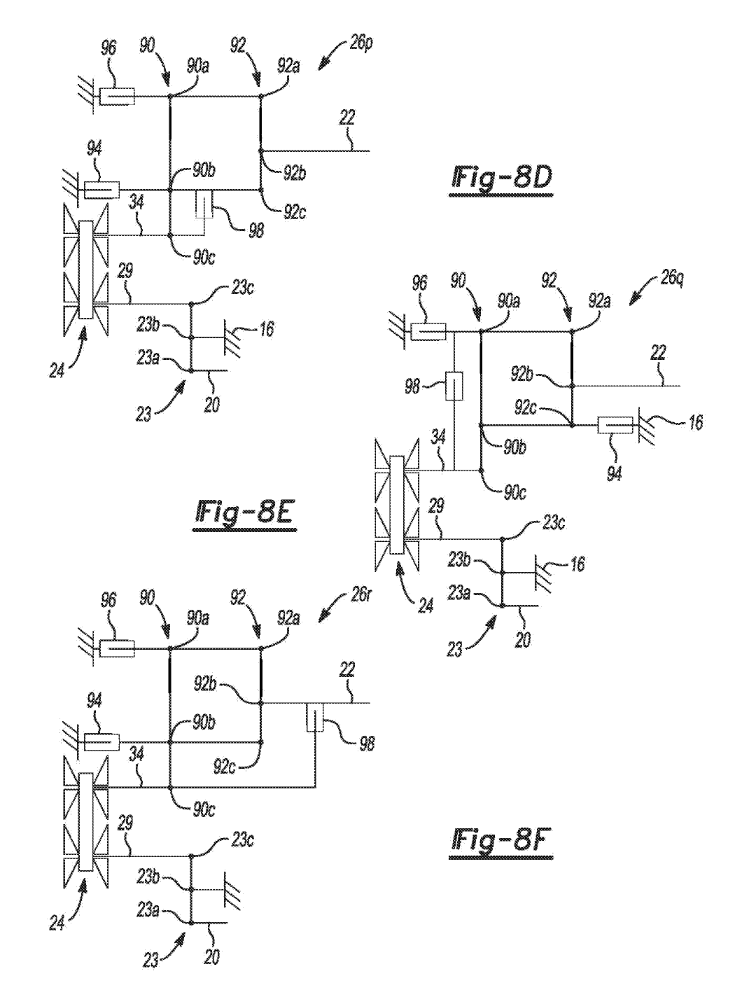

Turning now to FIGS. 8A-F, another set of configurations of the gearbox 26 are shown in lever diagram format. The gearboxes illustrated in FIGS. 8A-F include specific types of transmissions known as Simpson planetary gear sets, as will be described below. For example, the gearbox 26M includes a first planetary gear set 90 and a second planetary gear set 92. The first planetary gear set 90 has three nodes: a first node 90A, a second node 90B and a third node 90C. The second planetary gear set 92 has three nodes: a first node 92A, a second node 92B and a third node 92C.

The transfer member 34 is continuously coupled to the third node 90C of the first planetary gear set 90. The transmission output member 22 is coupled to the second node 92B of the second planetary gear set 92. The first node 90A of the first planetary gear set 90 is coupled to the first node 92A of the second planetary gear set 92. The second node 90B of the first planetary gear set 90 is coupled to the third node 92C of the second planetary gear set 92.

A first brake 94 selectively connects the second node 90B of the first planetary gear set 90 and the third node 92C of the second planetary gear set 92 with a stationary member or transmission housing 14. A second brake 96 selectively connects the first node 90A of the first planetary gear set 90 and the first node 92A of the second planetary gear set with the stationary member or transmission housing 14. A first clutch 98 selectively connects the first node 90A of the first planetary gear set 90 and the first node 92A of the second planetary gear set 92 with the second node 90B of the first planetary gear set 90 and the third node 92C of the second planetary gear set 92.

With reference to FIG. 8B, an alternate gearbox arrangement 26N is shown. The gearbox 26N is similar to that shown in FIG. 8A and therefore like components are indicated by like reference numbers. However, in FIG. 8B, the first clutch 98 is relocated and selectively connects the first node 90A of the first planetary gear set 90 and the first node 92A of the second planetary gear set 92 with the second node 92B of the second planetary gear set 92.

With reference to FIG. 8C, an alternate gearbox arrangement 26O is shown. The gearbox 26O is similar to that shown in FIG. 8A and therefore like components are indicated by like reference numbers. However, in FIG. 8C, the first clutch 98 is relocated and selectively connects the second node 90B of the first planetary gear set 90 and the third node 92C of the second planetary gear set 92 with the second node 92B of the second planetary gear set 92.

With reference to FIG. 8D, an alternate gearbox arrangement 26P is shown. The gearbox 26P is similar to that shown in FIG. 8A and therefore like components are indicated by like reference numbers. However, in FIG. 8D, the first clutch 98 is relocated and selectively connects the second node 90B of the first planetary gear set 90 and the third node 92C of the second planetary gear set 92 with the third node 90C of the first planetary gear set 90.

With reference to FIG. 8E, an alternate gearbox arrangement 26Q is shown. The gearbox 26Q is similar to that shown in FIG. 8A and therefore like components are indicated by like reference numbers. However, in FIG. 8E, the first clutch 98 is relocated and selectively connects the first node 90A of the first planetary gear set 90 and the first node 92A of the second planetary gear set 92 with the third node 90C of the first planetary gear set 90.

With reference to FIG. 8F, an alternate gearbox arrangement 26R is shown. The gearbox 26R is similar to that shown in FIG. 8A and therefore like components are indicated by like reference numbers. However, in FIG. 8F, the first clutch 98 is relocated and selectively connects the third node 90C of the first planetary gear set 90 with the second node 92B of the second planetary gear set 92.

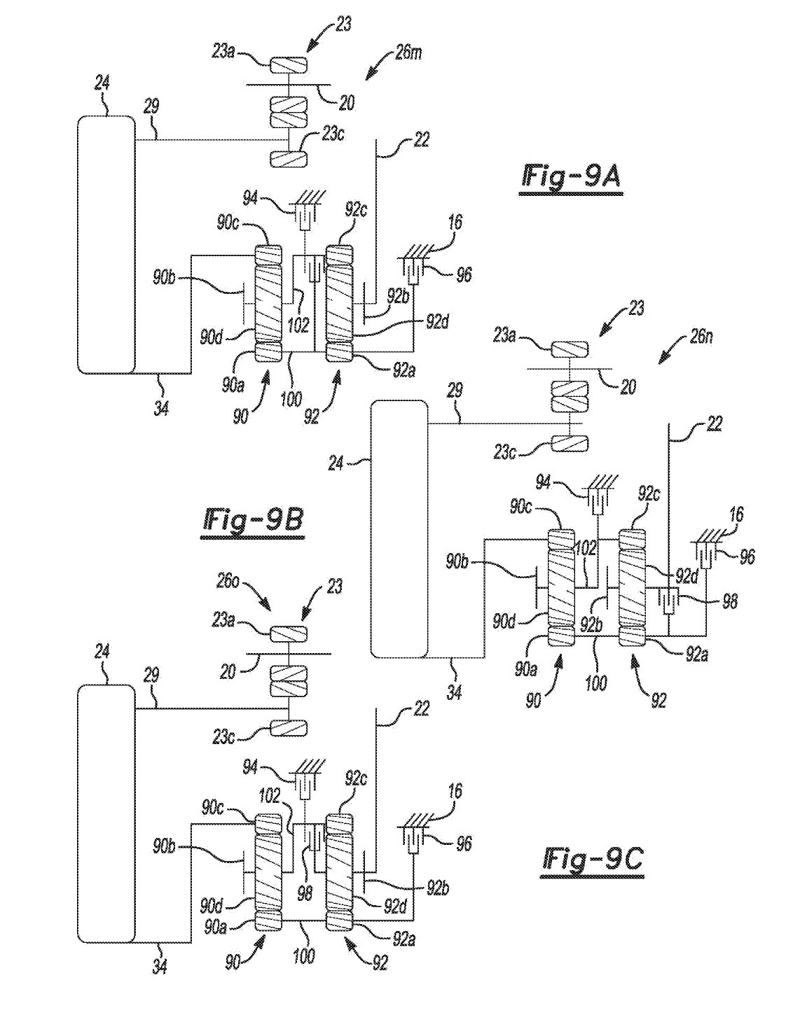

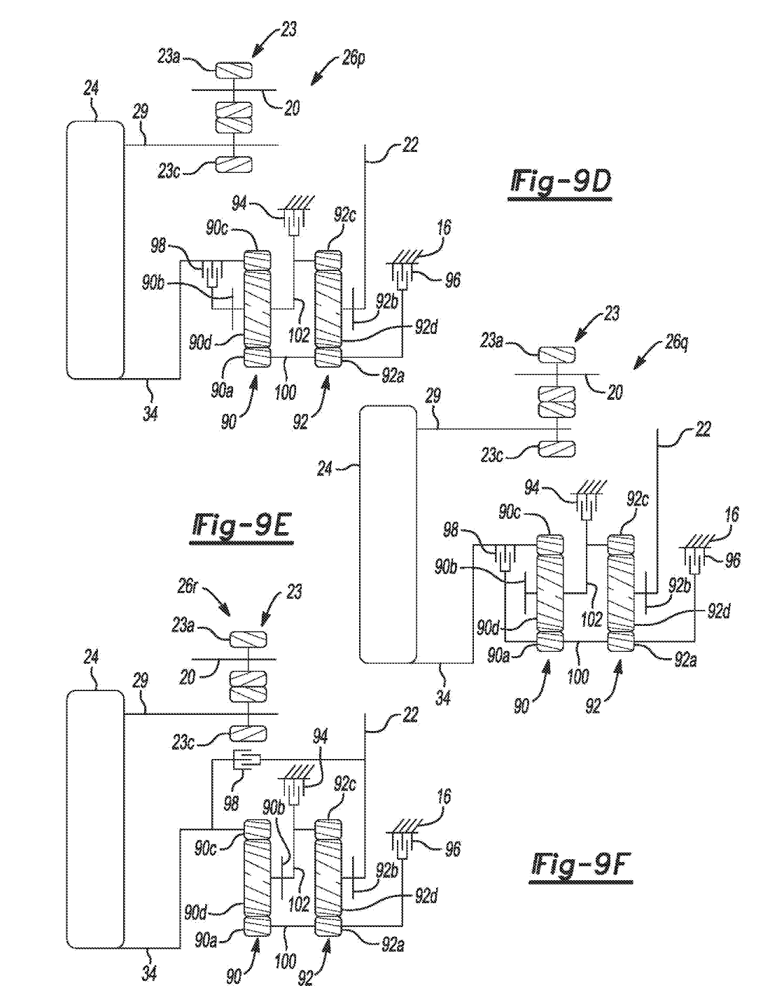

Turning now to FIGS. 9A-F, stick diagrams present schematic layouts of embodiments of the gearbox 26M-R according to the present invention. In FIGS. 9A-F the numbering from the lever diagram of FIGS. 8A-F are carried over. The clutches and couplings are correspondingly presented whereas the nodes of the planetary gear sets now appear as components of planetary gear sets such as sun gears, ring gears, planet gears and planet gear carriers.

For example, the planetary gear set 90 includes a sun gear member 90A, a ring gear member 90C, and a planet carrier member 90B that rotatably supports a set of planet gears 90D (only one of which is shown). The planet gears 90D are each configured to intermesh with both the sun gear member 90A and the ring gear member 90C. The sun gear member 90A is connected for common rotation with a first shaft or interconnecting member 100. The ring gear member 90C is connected for common rotation with the transfer member 34. The planet carrier member 90B is connected for common rotation with a second shaft or interconnecting member 102.

The planetary gear set 92 includes a sun gear member 92A, a ring gear member 92C, and a planet carrier member 92B that rotatably supports a set of planet gears 92D (only one of which is shown). The planet gears 92D are each configured to intermesh with both the sun gear member 92A and the ring gear member 92C. The sun gear member 92A is connected for common rotation with the first shaft or interconnecting member 100. The ring gear member 92C is connected for common rotation with the second shaft or interconnecting member 102. The planet carrier member 92B is connected for common rotation with the transmission output shaft 22.

The torque-transmitting mechanisms or brakes 94, 96 and clutch 98 allow for selective interconnection of the shafts or interconnecting members, members of the planetary gear sets and the housing. The torque-transmitting mechanisms are friction, dog or synchronizer type mechanisms or the like. For example, the first brake 94 is selectively engageable to connect the second shaft or interconnecting member 102 with the transmission housing 14 in order to restrict relative rotation of the member 102 and therefore the carrier member 90B of the first planetary gear set 90 and the ring gear member 92C of the second planetary gear set 92. The second brake 96 is selectively engageable to connect the first shaft or interconnecting member 100 with the transmission housing 14 in order to restrict relative rotation of the member 100 and therefore the sun gear member 90A and sun gear member 92A. In FIG. 9A, the clutch 98 is selectively engageable to connect the ring gear member 92C and the carrier member 90B with the sun gear member 90A and the sun gear member 92A.

Likewise, FIGS. 9B-3F illustrate stick diagrams of the corresponding gearbox arrangements 26M-26R which alter the location of the clutch 98, as described above. With reference to FIG. 9B, an alternate gearbox arrangement 26N is shown. The gearbox 26N is similar to that shown in FIG. 9A and therefore like components are indicated by like reference numbers. However, in FIG. 9B, the first clutch 98 is relocated and selectively connects the sun gear 90A of the first planetary gear set 90 and the sun gear 92A of the second planetary gear set 92 with the carrier member 92B of the second planetary gear set 92.

With reference to FIG. 9C, an alternate gearbox arrangement 26O is shown. The gearbox 26O is similar to that shown in FIG. 9A and therefore like components are indicated by like reference numbers. However, in FIG. 9C, the first clutch 98 is relocated and selectively connects the carrier member 90B of the first planetary gear set 90 and the ring gear 92C of the second planetary gear set 92 with the carrier member 92B of the second planetary gear set 92.

With reference to FIG. 9D, an alternate gearbox arrangement 26P is shown. The gearbox 26P is similar to that shown in FIG. 9A and therefore like components are indicated by like reference numbers. However, in FIG. 9D, the first clutch 98 is relocated and selectively connects the carrier member 90B of the first planetary gear set 90 and the ring gear 92C of the second planetary gear set 92 with the ring gear 90C of the first planetary gear set 90 and the second transfer member 34.

With reference to FIG. 9E, an alternate gearbox arrangement 26Q is shown. The gearbox 26Q is similar to that shown in FIG. 9A and therefore like components are indicated by like reference numbers. However, in FIG. 9E, the first clutch 98 is relocated and selectively connects the sun gear 90A of the first planetary gear set 90 and the sun gear 92A of the second planetary gear set 92 with the ring gear 90C of the first planetary gear set 90.

With reference to FIG. 9F, an alternate gearbox arrangement 26R is shown. The gearbox 26R is similar to that shown in FIG. 9A and therefore like components are indicated by like reference numbers. However, in FIG. 9F, the first clutch 98 is relocated and selectively connects the ring gear 90C of the first planetary gear set 90 with the carrier member 92B of the second planetary gear set 92.

The description of the invention is merely exemplary in nature and variations that do not depart from the gist of the invention are intended to be within the scope of the invention. Such variations are not to be regarded as a departure from the spirit and scope of the invention.

1. A transmission for a motor vehicle comprising:
a transmission input member;
a transmission output member;
a transfer gear set having a first transfer member connected for common rotation with the transmission input member and having a second transfer member in mesh with the first transfer member;
a continuously variable unit having a first pulley connected for common rotation with the second transfer member of the transfer gear, a second pulley, and an endless member wrapped around the first pulley and the second pulley;
a first planetary gear set having a plurality of members;
a second planetary gear set having a plurality of members, wherein the second planetary gear set is connected for common rotation to the first planetary gear set, the second pulley, and the transmission output member;
a clutch for selectively connecting for common rotation the first planetary gear set to the second planetary gear set;
a first brake for selectively connecting the first planetary gear set to a stationary member; and
a second brake for selectively connecting the second planetary gear set to the stationary member, and
wherein selective engagement of the clutch, first brake, second brake, and selective movement of the first pulley and second pulley provides two forward ranges of continuous gear ratios between the transmission input member and the transmission output member.

2. The transmission of claim 1 wherein the first planetary gear set includes a first member, a second member, and a third member and the second planetary gear set includes a first member, a second member, and a third member, wherein the first member of the first planetary gear set is connected for common rotation with the second member of the second planetary gear set, and the second member of the first planetary gear set is connected for common rotation with the third member of the second planetary gear set.

3. The transmission of claim 2 wherein the first member of the second planetary gear set is connected for common rotation with the second pulley and the second member of the first planetary gear set and the third member of the second planetary gear set are connected for common rotation with the transmission output member.

4. The transmission of claim 3 wherein the clutch selectively connects for common rotation the first member of the first planetary gear set and the second member of the second planetary gear set to the second member of the first planetary gear set and the third member of the second planetary gear set.

5. The transmission of claim 4 wherein the first brake selectively connects the first member of the first planetary gear set and the second member of the second planetary gear set to the stationary member.

6. The transmission of claim 5 wherein the second brake selectively connects the third member of the first planetary gear set to the stationary member.

7. The transmission of claim 6 wherein the first member of the first planetary gear set and the second member of the second planetary gear set are integrally formed as a single rotating member.

8. The transmission of claim 7 wherein the second member of the first planetary gear set and the third member of the second planetary gear set are integrally formed as a single rotating member.

9. The transmission of claim 8 wherein the first member of the first planetary gear set is a ring gear, the second member of the first planetary gear set is a planet carrier member, the third member of the first planetary gear set is a sun gear, the first member of the second planetary gear set is a sun gear, the second member of the second planetary gear set is a ring gear, and the third member of the second planetary gear set is a planet carrier member.

10. The transmission of claim 9 wherein the second member of the first planetary gear set and the third member of the second planetary gear set both support a plurality of stepped pinions and a plurality of pinions, wherein each of the plurality of stepped pinions have a first portion in mesh with the third member of the first planetary gear set and a second portion in mesh with the integrally formed first member of the first planetary gear set and the second member of the second planetary gear set and in mesh with the plurality of pinions, and wherein the plurality of pinions are in mesh with the first member of the second planetary gear set.

11. The transmission of claim 1 wherein the first gear member is co-planar with the second gear set.

12. The transmission of claim 1 further comprising a rotating member directly connected with the second transfer member and the second planetary gear set, and wherein the transfer gear set is an overdrive transfer gear set that increases a speed and decreases a torque of the rotating member relative to the transmission input member.

13. The transmission of claim 1 further comprising a rotating member directly connected with the second transfer member and the second planetary gear set, and wherein the transfer gear set is an underdrive transfer gear set that decreases a speed and increases a torque of the rotating member relative to the transmission input member.

14. The transmission of claim 1 further comprising a rotating member directly connected with the second transfer member and the second planetary gear set, and wherein the transfer gear set is a direct drive transfer gear set that maintains a speed and a torque of the rotating member relative to the transmission input member.

15. A transmission for a motor vehicle comprising:
a transmission input member;
a transmission output member;
a transfer gear set having a first transfer gear connected for common rotation with the transmission input member and having a second transfer gear in mesh with the first transfer gear;
a continuously variable unit having a first pulley connected for common rotation with the second transfer gear, a second pulley, and an endless member wrapped around the first pulley and the second pulley;
a planetary gear arrangement connected for common rotation with the second pulley and the transmission output member, wherein the planetary gear arrangement includes a first sun gear, a second sun gear, a planet carrier member, and a ring gear, wherein the planet carrier member supports a plurality of stepped pinions and plurality of non-stepped pinions, wherein the stepped pinions include a first portion in mesh with the first sun gear and a second portion in mesh with both the ring gear and the plurality of non-stepped pinions, and wherein the plurality of non-stepped pinions are each in mesh with the second sun gear; and
a plurality of torque transmitting mechanisms for selecting multiple modes of gear ratio ranges between the continuously variable unit and the transmission output member.

16. The transmission of claim 15 wherein the second sun gear is connected for common rotation with the second pulley of the continuously variable unit.

17. The transmission of claim 16 wherein the planet carrier member is connected for common rotation with the transmission output member.

18. The transmission of claim 15 wherein the plurality of torque transmitting mechanisms include a clutch that selectively connects for common rotation the planet carrier member to the ring gear.

19. The transmission of claim 15 wherein the plurality of torque transmitting mechanisms include a first brake that selectively connects for common rotation the ring gear to a stationary member.

20. The transmission of claim 15 wherein the plurality of torque transmitting mechanisms include a second brake that selectively connects for common rotation the first sun gear to a stationary member.
